(19) United States
(12) Patent Application Publication
(10) Pub. No.: US 2017/0076663 A1
(43) Pub. Date: Mar. 16, 2017

(54) IMAGE DISPLAY DEVICE AND DISPLAY CONTROL METHOD

(71) Applicant: JOLED INC., Tokyo (JP)

(72) Inventor: Masaru NISHIMURA, Kanagawa (JP)

(73) Assignee: JOLED INC., Tokyo (JP)

(21) Appl. No.: 15/126,070

(22) PCT Filed: Dec. 19, 2014
(86) PCT No.: PCT/JP2014/006354

§ 371 Date: Sep. 14, 2016

(30) Foreign Application Priority Data
Mar. 17, 2014 (JP) 2014-053753

(51) Int. Cl. G09G 3/3225

(52) U.S. Cl. CPC G09G 3/3225; G09G 2310/08; G09G 2300/04

(57) ABSTRACT

An image display device includes: a display panel substrate which includes pixels disposed in rows and columns; a control unit which outputs a clock signal; gate driver circuits each of which outputs a control signal to pixels row-by-row among the pixels included in the display panel substrate, in synchronization with the clock signal; lines disposed on the display panel substrate and supply the gate driver circuits with the clock signal by cascading the control unit and the gate driver circuits; and one or more source driver circuits each of which outputs pixel signals to pixels, among the pixels included in the display panel substrate, with a delay of a first delay time different for each of the gate driver circuits.

### TECHNICAL FIELD

The present disclosure relates to an image display device and a display control method.

### BACKGROUND ART

A conventional display device includes, for example, scanning lines (gate signal lines), signal lines (source signal lines), display pixels, and drive circuits. The display pixels are disposed at intersections of the gate signal lines and the source signal lines.

In general, a signal carried by each signal line in a display panel is delayed due to line resistance. Thus, the source signal line and the gate signal line for a certain pixel are out of phase.

To address this, for example, as disclosed in Patent Literatures 1 and 2, a liquid-crystal display corrects a phase difference (inconsistent timing) between the source signal line and the gate signal line by altering a time at which the source driver circuit outputs a signal, according to a position of a display pixel.

### CITATION LIST

### Patent Literature

[Patent Literature 1] Japanese Unexamined Patent Application Publication No. 2004.-094014

[Patent Literature 2] Japanese Unexamined Patent Application Publication No. 2004-325808

### SUMMARY OF INVENTION

### Technical Problem

The conventional display device takes into consideration delays of signals carried by the source signal lines and the gate signal lines, but delays of signals carried by other lines. Thus, display image quality degrades if a signal delay occurs on the other line.

Thus, the present disclosure provides an image display device and a display control method which improve display image quality.

### Solution to Problem

In order to solve the above problem, an image display device according to the present disclosure includes: a display panel substrate which includes pixels disposed in rows and columns; a control unit configured to output a clock signal; gate driver circuits each of which outputs a control signal to pixels row-by-row among the pixels included in the display panel substrate, in synchronization with the clock signal; lines disposed on the display panel substrate and supply the gate driver circuits with the clock signal by cascading the control unit and the gate driver circuits; and one or more source driver circuits each of which outputs pixel signals to pixels, among the pixels included in the display panel substrate, with a delay of a first delay time which is different for each of the gate driver circuits.

### Advantageous Effects of Invention

According to the present disclosure, the image display device and the display control method which improve display image quality are provided.

### BRIEF DESCRIPTION OF DRAWINGS

FIG. 1 is a schematic view of an example of an image display device according to an embodiment.

FIG. 2 is a circuit diagram of an example of a pixel according to the embodiment.

FIG. 3 is a diagram illustrating part of the image display device according to the embodiment.

FIG. 4A is a diagram illustrating a signal delay per gate driver circuit according to the embodiment.

FIG. 4B is a diagram illustrating the signal delay per gate driver circuit according to the embodiment.

FIG. 5A is a diagram showing delay times set for source driver circuits according to the embodiment.

FIG. 5B is a diagram showing an example of first delay times and second delay times according to the embodiment.

FIG. 6 is a diagram showing a configuration example of the source driver circuit according to the embodiment.

FIG. 7 is a schematic view of an example of an image display device according to a variation of the embodiment.

FIG. 8 is a diagram illustrating delay times set for source driver circuits according to the variation of the embodiment.

FIG. 9 is a schematic view of an example of an image display device according to another variation of the embodiment.

FIG. 10 is a diagram showing an example of a product of the image display device according to the embodiment.

### DESCRIPTION OF EMBODIMENTS

(Underlying Knowledge Forming Basis of the Present Disclosure)

The inventors have found the following problem with the conventional image display device described in the “Background Art” section.

In recent years, an organic electro-luminescent (EL) display which uses organic EL elements is known as a display device that uses current-driven light-emitting elements, The organic EL display has advantages of good viewing angle characteristics and low power consumption.

Unlike a liquid-crystal display, the organic EL display requires no backlight for displaying an image, and thus the thickness of the display panel can be reduced. In order to take advantage of this, preferably, the gate driver circuit has a structure (PCB-less configuration) which does not utilize a printed circuit board (PCB).

In an organic EL display having the PCB-less configuration, power supply lines for the gate driver circuits and lines such as control signal lines, etc, are disposed on a display panel substrate and film substrates (COF (Chip On Film) substrate) on which the gate driver circuits are mounted. The lines disposed on the COF substrates and the lines disposed on the display panel substrate are not allowed to cross or, if they are crossed, there is a great risk of short-circuiting at cross points. Accordingly, desirably, the gate driver circuits are connected from one to the next in tandem.

In this case, there arises a problem that the resistances of the lines formed on the display panel substrate are greater than the resistances of the lines on the COF substrates. For example, the resistances of the lines on the COF substrates are about 0.1Ω to about a few ohm, whereas the resistances of the lines on the display panel substrate are a few hundreds ohm to a few thousands ohm. This undesirably increases delays between the COF substrates. As a result of the delays between the COF substrates, stripes appear on a display image, degrading display image quality.

Thus, in order to solve such a problem, the present disclosure provides an image display device and a display control method which allow a reduction of a degradation of display image quality due to line delays of signals between the COF substrates, and improvement in image quality.

Specifically, an image display device according to one aspect of the present disclosure includes: a display panel substrate which includes pixels disposed in rows and columns; a control unit configured to output a clock signal; gate driver circuits each of which outputs a control signal to pixels row-by-row among the pixels included in the display panel substrate, in synchronization with the clock signal; lines disposed on the display panel substrate and supply the gate driver circuits with the clock signal by cascading the control unit and the gate driver circuits; and one or more source driver circuits each of which outputs pixel signals to pixels, among the pixels included in the display panel substrate, with a delay of a first delay time which is different for each of the gate driver circuits.

This allows a reduction of degradation of display quality due to signal delays between the gate driver circuits.

Hereinafter, embodiments according to the present disclosure will be described in detail, with reference to the accompanying drawings. It should be noted that unnecessarily detailed description may be omitted. For example, detailed description of well-known matters or description previously set forth with respect to substantially the same configuration may be omitted. This is to avoid unnecessary redundancy of description below and for facilitating an understanding of the present disclosure by a person skilled in the art.

The inventors provide the accompanying drawings and the description below for a thorough understanding of the present disclosure by a person skilled in the art, and the accompanying drawings and the description are thus not intended to be limiting the subject matter recited in the claims appended hereto.

The figures are schematic illustration and do not necessarily illustrate the present disclosure as precisely. In the figures, the same reference sign is given to refer to the same component.

### Embodiment

### 1. Overview of Image Display Device

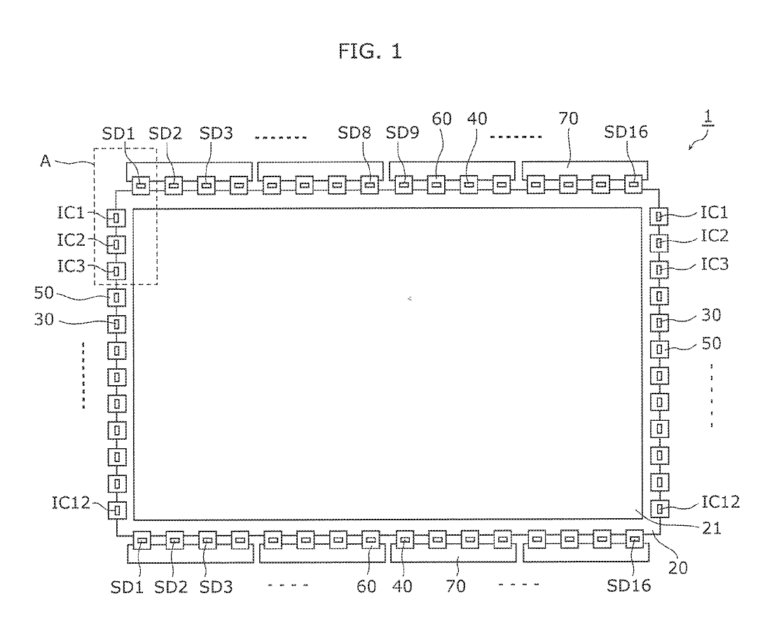

First, an overview of an image display device 1 according to the present embodiment is described with reference to FIG. 1. FIG. 1 is a diagram showing configuration of the image display device 1 according to the present embodiment.

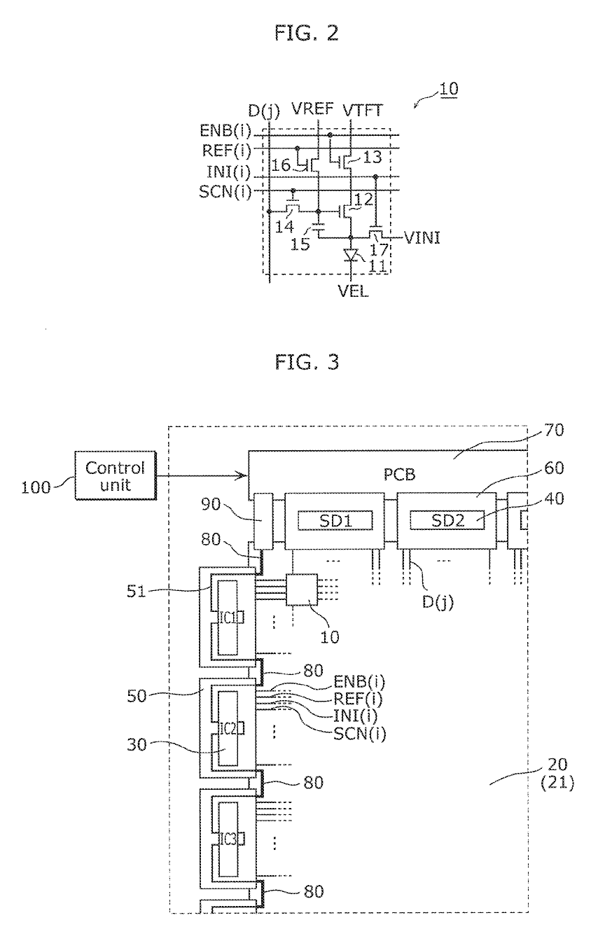

As shown in FIG. 1, the image display device 1 includes a display panel substrate 20, gate driver circuits 30, source driver circuits 40, first COF substrates 50, second COF substrates 60, and PCBs 70. Although not shown in FIG. 1, it should be noted that pixels 10 (see FIGS. 2 and 3) are disposed in rows and columns in a display area 21 of the display panel substrate 20.

The image display device 1 according to the present embodiment has the PCB-less configuration. Specifically, the image display device 1 does not include PCBs for providing a line connecting the gate driver circuits 30. To be more specific, the lines connecting the gate driver circuits 30 are disposed on the display panel substrate 20.

It should be noted that in the present embodiment, the gate driver circuits 30 and the first COF substrates 50 are in one-to-one correspondence, and each first COF substrate 50 includes a corresponding one of the gate driver circuits 30 mounted thereon.

Likewise, the source driver circuits 40 and the second COF substrates 60 are in one-to-one correspondence, and each second COF substrate 60 includes a corresponding one of the source driver circuits 40 mounted thereon.

As an example, the image display device 1 according to the present embodiment includes twelve gate driver circuits 30 and twelve first COF substrates 50 on each of the left side and right side of the display panel substrate 20. The twelve gate driver circuits 30 are referred to as IC1 through IC12, starting from the uppermost gate driver circuit 30. Corresponding two gate driver circuits 30 each disposed on the left side and right side of the display panel substrate 20 are connected to each other by the same control line and perform the same operation. For example, the IC1 on the left side and the IC1 on the right side are connected.

Likewise, as an example, the image display device 1 according to the present embodiment includes sixteen source driver circuits 40 and sixteen second COF substrates 60 on each of the top side and the bottom side of the display panel substrate 20. The sixteen source driver circuits 40 are referred to as SDI through SD16, starting from the leftmost source driver circuit 40. Corresponding two source driver circuits 40 each disposed on the top side and bottom side of the display panel substrate 20 are connected to each other by the same signal line and perform the same operation. For example, the SD1 on the top side and the SD1 on the bottom side are connected.

It should be noted that the top, bottom, left, and right as used herein refer to the directions in FIG. 1. Each direction is by way of example and the present disclosure is not limited thereto.

### 2. Pixels

First, the pixels 10 according to the present embodiment are described with reference to FIG. 2. FIG. 2 is a circuit diagram of the pixel 10 according to the present embodiment.

The pixels 10 are disposed in m rows and n columns, for example. The m and n depend on the size and resolution of the display area 21. For example, if the display area 21 has a resolution known as 4k×2k and sub-pixels corresponding to the primary colors RGB are adjacent to one another in a row, m is 1920 and n is 3840×3.

The pixel 10 constitutes one of light-emitting pixels corresponding to the primary colors RGB, for example. To be more specific, the pixels 10 as used herein correspond to sub-pixels. The pixel 10, as shown in FIG. 2, includes a light-emitting element 11, a drive transistor 12, an enable switch 13, a scan switch 14, a capacitor 15, a REF switch 16, and an INI switch 17.

The pixels 10 belonging to the row i (where i is an integer from 1 to m) are connected to an ENB (i) signal line, a REF (i) signal line, an INI (i) signal line, and a SCN (i) signal line. Predetermined control signals are supplied to the respective signal lines by the gate driver circuit 30. The predetermined control signals are, specifically, an enable signal, a REF control signal, an INI control signal, and a scan signal.

The pixels 10 belonging to the column j (where j is an integer from 1 to n) are connected to a D (j) signal line. A voltage according to a luminance at which the pixel 10 is to emit light is supplied as a pixel signal to the D (j) signal line from the source driver circuit 40.

The ENB (i) signal line carries the enable signal which controls light-emission and non-emission of the pixel 10 belonging to the row i. The enable signal controls turning on and off of the enable switch 13 included in a relevant pixel 10.

The SCN (i) signal line carries the scan signal (also referred to as a write signal) which controls writing pixel data to the pixel 10 belonging to the row 1. The scan signal controls turning on and off of the scan switch 14 included in a relevant pixel 10.

The REF (i) signal line carries the REF control signal which controls supply of a reference voltage to the pixel 10 belonging to the row i. The REF control signal controls turning on and off of the REF switch 16 included in a relevant pixel 10.

The INI (i) signal line carries the INI control signal which controls supply of an initialization voltage to the pixel 10 belonging to the row i. The INI control signal controls turning on and off of the INI switch 17 included in a relevant pixel 10.

The D (j) signal line is a data line which carries, as a pixel signal, a voltage according to a luminance at which the pixel 10 belonging to the column j is to emit light. The pixel signal is provided to the capacitor 15 included in a relevant pixel 10 via the scan switch 14 by the control of the scan signal. In the following, the notations (i) and (j) in the names of the signal lines are omitted when the position of the pixel 10 is not particularly specified.

In the pixel 10 illustrated in FIG. 2, the light-emitting element 11 is an organic EL element and, by way of example, a light-emitting element also known as an organic light-emitting diode (OLED). The light-emitting element 11 is an example of a current-driven light-emitting element which emits light having a brightness according to a magnitude of current through the light-emitting element. The light-emitting element 11 has the anode connected to the source of the drive transistor 12, and the cathode connected to a power supply line VEL.

The drive transistor 12 is a driver which supplies the current to the light-emitting element 11. The drive transistor 12 has the gate connected to one electrode of the capacitor 15, and the source connected to the other electrode of the capacitor 15 and the anode of the light-emitting element 11.

With this connection, a voltage held at the capacitor 15, namely, the voltage according to the luminance at which the pixel 10 is to emit light is applied between the gate and source of the drive transistor 12. This causes the drive transistor 12 to supply the light-emitting element 11 with an amount of current according to the voltage held at the capacitor 15.

The enable switch 13 is a switch transistor which turns on and off the supply of the current by the drive transistor 12 to the light-emitting element 11. The enable switch 13 turns on and off according to the enable signal. The enable signal enables and disables the light emission of the pixels 10 row-by-row, among the pixels 10 in the rows and columns.

Specifically, when the ENB signal line is high, the enable switch 13 is on and a voltage VTFT is supplied to the drain of the drive transistor 12. On the other hand, when the ENB signal line is low, the enable switch 13 is off and supply of the voltage VTFT to the drain of the drive transistor 12 is interrupted.

The scan switch 14 is a switch transistor for writing to the capacitor 15 the voltage representative of luminance as the pixel data. The scan signal is the write signal for selecting the pixel 10 in a row-by-row fashion, among the pixels 10 in rows and columns, and writing a voltage representative of a luminance to the pixel 10 belonging to the selected row.

Specifically, when the SCN signal line is high, the scan switch 14 is on and the voltage carried by the data line (D (j) signal line) is written as pixel data to the capacitor 15. On the other hand, when the SCN signal line is low, the scan switch 14 is off and the connection between the SCN signal line and the capacitor 15 is electrically decoupled.

The capacitor 15 disposed between the gate and source of the drive transistor 12 holds the voltage representative of luminance as the pixel data.

The REF switch 16 is a switch transistor for providing one electrode of the capacitor 15 with a reference voltage VREF. The INI switch 17 is a switch transistor for providing the other electrode of the capacitor 15 with an initialization voltage VIM. The REF switch 16 and the INI switch 17 are used to compensate for threshold.

The threshold compensation causes the capacitor 15 to hold a voltage corresponding to an actual threshold voltage of the drive transistor 12. More specifically, the threshold compensation refers to compensating for a threshold shift of the drive transistor 12 included in the pixel 10.

Thus, first, using the reference voltage VREF and the initialization voltage VINI, a maximum threshold voltage (i.e., a voltage regarded as being a maximum when a threshold shift occurs) is set to the capacitor 15 as an initialization voltage for the threshold compensation. Further, the initialization voltage is reduced to a voltage corresponding to an actual threshold voltage of the drive transistor 12 by passing current through the drive transistor 12 while the light-emitting element 11 is in non-emissive state. This is the end of the threshold compensation operation.

This causes the capacitor 15 to hold the voltage corresponding to the actual threshold voltage of the drive transistor 12 connected to the capacitor 15. In this state, the pixel data voltage is additionally written to the capacitor 15. Thus, the threshold compensation operation is to compensate for a threshold variation due to a threshold shift as a change in pixel 10 over time, and is carried out every time immediately before pixel data is written to the capacitor 15.

It should be noted that the drive transistor 12 and the switches included in the pixel 10 are each formed of a thin film transistor (TFT), for example. The drive transistor 12 and the switches may be any of n-type TFTs and p-type TFTs.

### 3. Detailed Configuration of Image Display Device

Next, detailed configuration of the image display device 1 according to the present embodiment is described with reference to FIGS. 1 and 3. FIG. 3 is a diagram showing part of the image display device 1 according to the present embodiment.

As illustrated in FIG. 3, the image display device 1 includes lines 80, film substrates 90, and a control unit 100, in addition to the components shown in FIG. 1. In the following, detailed configuration of the components included in the image display device 1 is described.

### 3-1. Display Panel Substrate

The display panel substrate 20 includes the pixels 10 disposed in rows and columns. Specifically, the display panel substrate 20 includes a gate signal line for each row, and a source signal line for each column. The pixels 10 are disposed in rows and columns at intersections between the gate signal lines and the source signal lines. The gate signal line is, for example, the ENB signal line, the REF signal line, the INI signal line, and the SCN signal line, as illustrated in FIG. 2. The source signal line is, for example, the D signal line.

The display panel substrate 20 is, for example, a glass substrate. Alternatively, the display panel substrate 20 may be a substrate made of resin such as acrylic. While the present embodiment is to be described with reference to the display panel substrate 20 having a rectangular shape, the present disclosure is not limited thereto. The display panel substrate 20 may be in any other shape such as a round shape.

### 3-2. Driver Circuit

The gate driver circuit 30 outputs control signals to the pixels 10 row-by-row, in synchronization with a clock signal supplied from the control unit 100. The control signals are, for example, the enable signal, the scan signal, the REF control signal, and the INI control signal.

Specifically, the gate driver circuit 30 scans the ENB (1) signal line to the ENB (m) signal line, the SCN (1) signal line to the SCN (m) signal line, the REF (1) signal line to the REF (m) signal line, and the INI (1) signal line to the INT (m) signal line. Stated differently, the gate driver circuit 30 outputs the enable signal, the scan signal, the REF control signal, and the INT control signal to the pixels 10, in a row-by-row fashion.

The source driver circuit 40 outputs a pixel signal to the pixel 10 with a delay of a delay time different for each gate driver circuit 30. The delay is described in detail below,

Specifically, the source driver circuits 40 supply the D (1) signal line to the D (n) signal lines with voltages, as pixel signals, representative of brightness (luminance value) at which the pixels 10 belonging to the respective columns are to emit light, in synchronization with the clock signal supplied from the control unit 100. The source driver circuits 40 are also described in detail below.

### 3-3 COF Substrate and Film Substrate

The first COF substrate 50 is, by way of example, a film substrate connected to the display panel substrate 20. The gate driver circuit 30 is mounted on the first COF substrate 50. A metal line 51 and terminal portions (not shown) for carrying the clock signal are formed on the first COF substrate 50. The metal line 51 is electrically connected to the lines 80 on the display panel substrate 20 via the terminal portions.

Moreover, although not shown, a metal line and terminal portions are formed on the first COF substrate 50. The metal line is used to carry the control signal output from the gate driver circuit 30. The metal line is electrically connected to the signal lines (the ENB signal line, the REF signal line, the INI signal line, and the SCN signal line) on the display panel substrate 20 via the terminal portions.

The second COF substrate 60 is, by way of example, a film substrate connected to the display panel substrate 20. The source driver circuit 40 is mounted on the second COF substrate 60. Although not shown, a metal line and terminal portions are formed on the second COF substrate 60, and the metal line is connected via the terminal portions to a line on the PCB 70 and the signal line (D signal line) on the display panel substrate 20.

The film substrates 90 are, as with the second COF substrates 60, connected to the display panel substrate 20 and the PCB 70. Although not shown, the film substrate 90 includes a line for electrically connecting the line 80 and the line on the PCB 70.

The first COF substrates 50, the second COF substrates 60, and the film substrates 90 are each configured of, for example, a base and coverlay using an insulating material, a metal foil, and adhesive. For example, polyimide or the like is used as the materials of the base and coverlay of the first COF substrates 50, the second COF substrates 60, and the film substrates 90. For example, a copper foil or the like is used as a material of the metal foil. For example, epoxy-based adhesive or the like is used as a material of the adhesive.

The first COF substrates 50, the second COF substrates 60, and the film substrates 90 are connected to the display panel substrate 20, using, for example, anisotropic conductive films (ACF) or the like. The second COF substrate 60 and the film substrate 90 are also connected to the PCB 70, using an ACF or the like.

### 3-4. PCB

The PCBs 70 are printed circuit boards which connect the control unit 100 and the second COF substrates 60. Further, the PCB 70 connects the control unit 100 and the film substrate 90. IL should be noted that the PCB 70 is connected to the control unit 100 by a cable such as a flexible flat cable (FFC), for example.

Although not shown, the PCBs 70 each include a line for carrying the clock signal output from the control unit 100 and the various signals including the control signals and a video signal, etc. to the gate driver circuits 30 and the source driver circuits 40.

### 3-5. Line

The lines 80 are disposed on the display panel substrate 20. The lines 80 cascade the control unit 100 and the gate driver circuits 30 and through which the clock signal is supplied to the gate driver circuits 30. Specifically, as illustrated in FIG. 3, the lines 80 and the metal lines 51 on the first COF substrates 50 cascade the control unit 100 and the gate driver circuits 30. More specifically, the lines 80 are connected to the control unit 100 via the film substrate 90, the PCB 70, and the cable such as FFC. The lines 80 are configured of aluminum, copper, silver, or indium tin oxide (ITO), for example.

### 3-6. Control Unit

The control unit 100 outputs clock signals. For example, the control unit 100 is a timing controller (TCON) and controls the timing of operations between the gate driver circuit 30 and the source driver circuit 40.

Specifically, the control unit 100 supplies clock signals each to the gate driver circuits 30 and the source driver circuits 40. For example, the control unit 100 supplies two synchronized clock signals each to the gate driver circuits 30 and the source driver circuits 40. For example, the control unit 100 generates two synchronized clock signals, based on one clock signal.

For example, the clock signal supplied to the gate driver circuits 30 has a frequency of 150 kHz to 300 kHz. The control unit 100 is located at the beginning of the downstream of the gate driver circuits 30 cascaded from one to the next. For example, the clock signal supplied to the source driver circuits 40 has a frequency in the order of megahertz to gigahertz. It should be noted that the control unit 100 may not supply the clock signal to the source driver circuits 40, and the source driver circuits 40 may each generate a clock signal from data signal by clock recovery scheme.

Alternatively, the control unit 100 may supply the same clock signal to the gate driver circuit 30 and the source driver circuit 40.

Moreover, the control unit 100 supplies the gate driver circuit 30 with raw signals of the signals supplied to the respective signal lines connected to each pixel 10. Specifically, the control unit 100 supplies raw signals of the enable signal, REF control signal, INI control signal, and scan signal to an uppermost gate driver circuit 30 in the cascade.

Moreover, the control unit 100 supplies the source driver circuits 40 with a video signal based on video data. Further, the control unit 100 supplies the source driver circuits 40 with parameters with which delay times are set for the source driver circuits 40.

### 4. Signal Delay Between Gate Driver Circuits

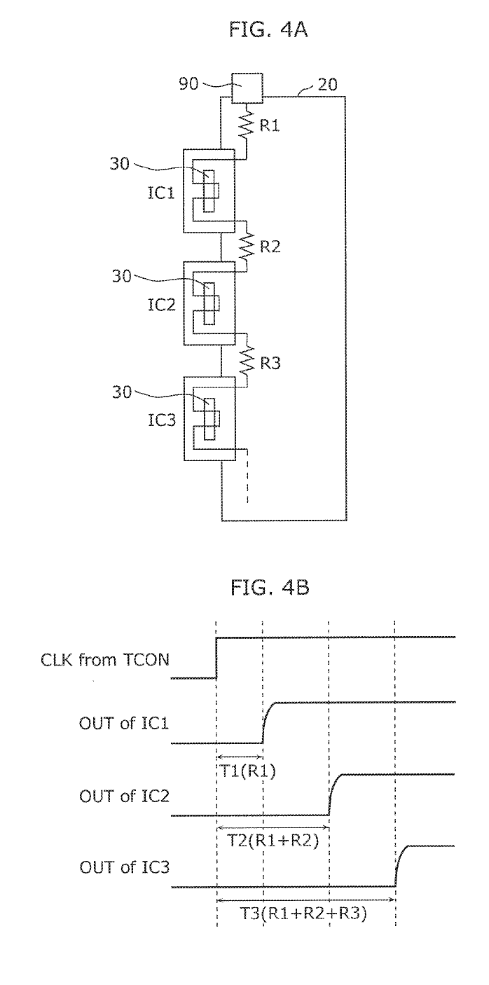

Next, signal delays between the gate driver circuits 30 are described with reference to FIGS. 4A and 4B. FIG. 4A is a diagram illustrating the signal delay per gate driver circuit 30 according to the present embodiment. FIG. 4B is a diagram illustrating a clock signal delay per gate driver circuit 30 according to the present embodiment.

As described above, the image display device 1 according to the present embodiment has the PCB-less configuration. Thus, the lines 80 which carry the clock signal are disposed on the display panel substrate 20.

Specifically, the clock signal output from the control unit 100 is supplied to the gate driver circuit 30 (IC1) via the cable connecting the control unit 100 and the PCB 70, the PCB 70, and the film substrate 90, the line 80, the metal line 51. The clock signal supplied to the IC1 is transferred to the subsequent gate driver circuits 30 (IC2, IC3, etc.) one after another via the lines 80 and the metal lines 51.

Typically, a signal carried by a line is delayed due to a line resistance and stray capacitance. A delay amount increases in proportional to the product of the line resistance and the stray capacitance. Accordingly, the clock signal output from the control unit 100 delays longer for the gate driver circuit 30 farther away from the control unit 100.

At this time, the line resistance of the cable connecting the control unit 100 and the PCB 70, the line resistance of the PCB 70, the line resistance of the film substrate 90, and the line resistance of the metal line 51 are small to an extent that they can be ignored. Stated differently, as compared to the resistance of the metal line 51 or the like, the line 80 has a great resistance value that cannot be ignored. For example, as described above, the line resistance of the metal line 51 is, for example, about 0.1Ω to about a few ohm, whereas the resistance of the line 80 is, for example, about a few hundreds ohm to about a thousand ohm.

A clock signal CLK output from the control unit 100 is, first, input to the first gate driver circuit 30 (IC1). At this time, as illustrated in FIG. 4A, the clock signal CLK is carried by the line 80 where the resistance value is R1, and thus the clock signal (OUT of IC1) output from the IC1 delays by a delay amount T1, as illustrated in FIG. 4B. The delay amount T1 at this time is a time period corresponding to the resistance value R1. For example, T1 is a value of 1 microsecond or less.

Likewise, the clock signal through the IC1 passes IC2 and IC3 sequentially. The clock signal (OUT of IC2) output from the IC2 further passes through the line 80 where the resistance value is R2, and thus delays by a delay amount T2, as illustrated in FIG. 4B. The delay amount T2 at this time is a time period corresponding to the resistance values R1 plus R2. The clock signal (OUT of IC3) output from the IC3 further passes through the line 80 where the resistance value is R3, and thus delays by a delay amount T3, as illustrated in FIG. 4B. The delay amount T3 at this time is a time period corresponding to the resistance values R1 plus R2 plus R3.

Likewise, an output of each of the subsequent gate driver circuits 30 delays by a delay amount corresponding to a resistance of the total number of the lines 80 through which the clock signal passes. Stated differently, an amount of delay of the clock signal output from a certain gate driver circuit 30 corresponds to a resistance of the total number of lines 80 cascading the control unit 100 down to a gate driver circuit 30 corresponding to the amount of delay. It should be noted that a delay amount due to the metal line 51 on the first COF substrate 50 is as little as can be ignored, and thus it can be regarded that there is no delay between the clock signal input to and output from a certain gate driver circuit 30. In other words, it can be regarded that there is no delay of the clock signal within the gate driver circuit 30.

As described above, since the resistance of the line 80 is great, the delay of the clock signal due to the lines 80 is problematic when bringing the control signals and a pixel signal supplied to each pixel 10 to be in phase.

### 5. Delay Time Set To Source Driver Circuit

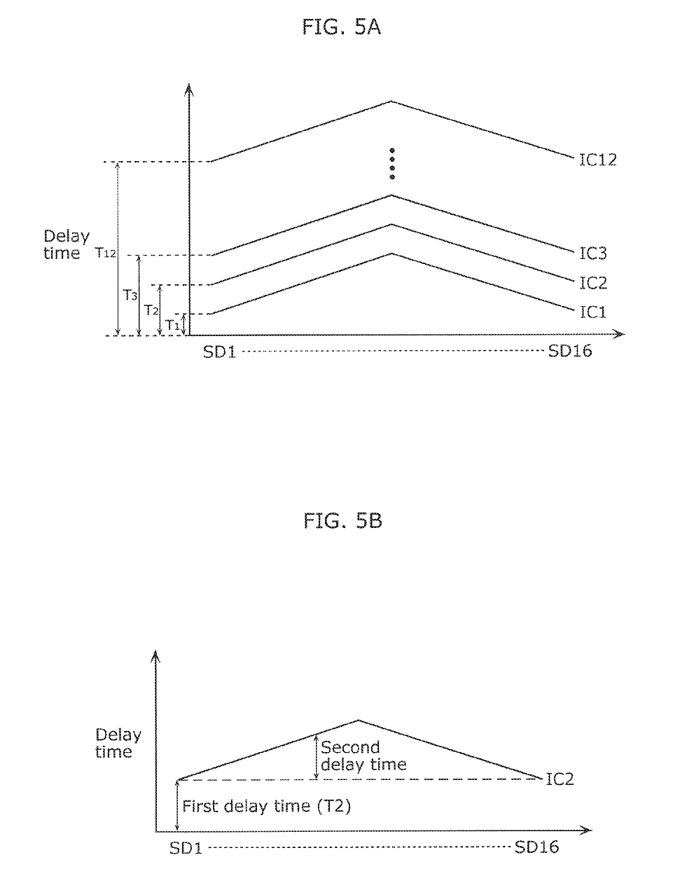

Next, delay times set for the source driver circuits 40 according to the present embodiment are described with reference to FIGS. 5A and 5B. FIG. 5A is a diagram showing delay times set for the source driver circuits 40 according to the present embodiment. FIG. 5B is a diagram showing an example of first delay times and second delay times according to the present embodiment.

In an ideal image display device where no delay occurs in any line, the source driver circuit 40 may output a pixel signal column-by-column, in synchronization with the scan signal for causing the gate driver circuit 30 to select a pixel 10. For example, the source driver circuit 40 may supply the D signal line with a voltage representative of luminance at a moment the potential of the SCN signal line changes from low to high.

The timing of operations between the gate driver circuit 30 and the source driver circuit 40 is controlled by the control unit 100. Specifically, the gate driver circuit 30 outputs a scan signal and the source driver circuit 40 outputs a pixel signal, in synchronization with the clock signal output from the control unit 100.

In the image display device 1 according to the present embodiment, as illustrated in FIG. 4B, the clock signal delays by a delay amount different for each gate driver circuit 30, Thus, the source driver circuit 40 according to the present embodiment outputs a pixel signal to the pixel 10 with a delay of the first delay time different for each gate driver circuit 30.

The first delay time in this case is an amount of time retarded from a moment a gate driver circuit 30 corresponding to the first delay time outputs a scan signal in the case where the line 80 causes no delay. For example, if the gate driver circuit 30 outputs a scan signal in response to the rise of a predetermined pulse of the clock signal from the control unit 100, the first delay time is an amount of time retarded from a moment the clock signal having the predetermined pulse is output from the control unit 100.

The first delay times correspond to the respective gate driver circuits 30. Specifically, the first delay time depends on a line resistance of the lines 80 from the control unit 100 to a gate driver circuits 30 corresponding to the first delay time in the cascade.

For example, if the source driver circuit 40 outputs a pixel signal according to a scan timing of the IC1, the output of the pixel signal from the source driver circuit 40 is delayed by a delay time corresponding to T1 from a pulse at a moment output from the control unit 100. Likewise, if the source driver circuit 40 outputs a pixel signal according to a scan timing of the IC2, the output of the pixel signal from the source driver circuit 40 is delayed by a delay time corresponding to T2 from a pulse at a moment output from the control unit 100.

The farther the gate driver circuit 30 is away from the control unit 100, the greater the line resistance of the lines 80 through which the clock signal is carried. In other words, the farther the gate driver circuit 30 is away from the control unit 100, the longer the delay of the clock signal to be input thereto. Stated differently, the delay with which the clock signal is input to the gate driver circuit 30 is longer for the gate driver circuit 30 located farther downstream of the gate driver circuits 30 in the cascade. Accordingly, the farther downstream in the cascade the gate driver circuit 30 is located, the longer the first delay time corresponding to the gate driver circuit 30.

Specifically, as illustrated in FIG. 5A, the first delay times (T1 to T12) for the IC1 to IC12 increase in the order starting from the IC1 to the IC12. In other words, the first delay times for the IC1 to IC12 increase as depicted by the parallel inverse chevron graphs in FIG. 5A. For example, a difference (T2−T1) between a first delay time corresponding to the IC1 and a first delay time corresponding to the IC2 depends on the line resistance (R2) of the line 80 between the IC1 and the IC2. As the line resistances between the gate driver circuits 30 accumulate, the first delay times for the IC1 to IC12 increases in turn. It should be noted that the IC1 is located at the beginning of the downstream of the gate driver circuits 30 in the cascade and the IC12 is located at the end of the downstream.

Further, the source driver circuit 40 according to the present embodiment sets different delay times for different column-groups each consisting of one or more columns of the pixels 10. To be more specific, the source driver circuit 40 outputs pixel signals to a column-group of the pixels 10 with a total delay time that is the sum of the first delay time as discussed above and the second delay time different for each column-group of the pixels 10.

For example, FIG. 5B is a diagram showing an example of the delay time corresponding to the IC2. The delay time for the source driver circuit 40 is a total delay time which is the sum of the first delay time and the second delay time, where the first delay time corresponds to the delay amount T2 corresponding to the resistances R1 plus R2 and the second delay time is different for each column-group.

The farther the column-group is away from the gate driver circuits 30, the longer the second delay time for the column-group. in the following, for ease of explanation, the description is given with reference to the second delay time being different for each column of the pixels 10.

The delay of the clock signal output from the control unit 100 due to the lines 80 can be resolved by the first delay time as discussed above. However, similarly, the scan signal output from the gate driver circuit 30 delays when being carried by the SCN signal line.

Thus, the source driver circuit 40 according to the present embodiment outputs a pixel signal with a delay for each column, based on the second delay time which increases with an increasing distance from the gate driver circuit 30 to the column corresponding to the gate driver circuit 30.

As illustrated in FIG. 1, since the gate driver circuits 30 are disposed on the left and right sides of the display panel substrate 20, pixels 10 having a greatest distance from the gate driver circuit 30 are positioned in the center portion of the display area 21. Specifically, such pixels 10 are ones that are supplied with pixel signals from SD8 and SD9 illustrated in FIG. 1. Accordingly, as illustrated in FIGS. 5A and 5B, the graphs depicting the delay times are inverse chevron graphs which have longest delay in the middle.

It should be noted that if the line resistance in the display area 21 is so small that can be ignored, the graphs depict horizontal straight lines, rather than inverse chevrons. To be more specific, the source driver circuit 40 outputs a pixel signal with a delay of the first delay time only. Stated differently, the source driver circuit 40 outputs a pixel signal without a delay for each column-group of the pixels 10, but with a delay for each gate driver circuit 30.

### 6. Detailed Configuration of Source Driver Circuit

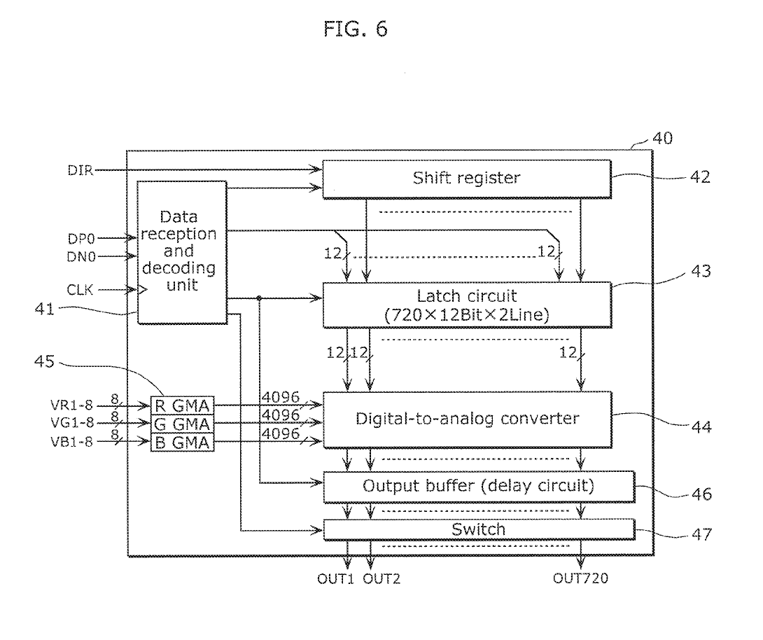

Next, as described above, detailed configuration of the source driver circuits 40 to which delay amounts are configurable are described with reference to FIG. 6. FIG. 6 is a diagram showing configuration of the source driver circuits 40 according to the present embodiment.

As illustrated in FIG. 6, the source driver circuit 40 includes a data reception and decoding unit 41, a shift register 42, a latch circuit 43, a digital-to-analog converter 44, a gamma setting circuit 45, an output buffer 46, and a switch 47.

Digital data of a video signal is input to the data reception and decoding unit 41. The data reception and decoding unit 41 receives, for example, differential input signals DP0 and DN0, performs serial-to-parallel conversion or the like on the differential input signals DP0 and DN0, and outputs them to the latch circuit 43. Moreover, the clock signal output from the control unit 100 is input to the data reception and decoding unit 41.

A DIR which switches a shift direction is applied to the shift register 42. The DIR is a 1-bit value for setting a direction in which the video signal output from the data reception and decoding unit 41 is captured into the latch circuit 43.

The latch circuit 43 latches the video signal input thereto. For example, the latch circuit 43 holds the video signal for a period of time according to a signal output from the control unit 100. The latch circuit 43 latches data at a predetermined timing and outputs the data to the digital-to-analog converter 44.

The digital-to-analog converter 44 carries out gamma transform on the video signal, according to voltages set to the gamma setting circuit 45, and outputs an analog voltage produced from the gamma transform to the output buffer 46. The analog voltage corresponds to a pixel signal supplied to each pixel.

The gamma setting circuit 45 sets a gamma curve based on, for example, 8-bit input voltage for each of R, G, and B. The gamma setting circuit 45 sets the gamma curve, thereby determining a relationship between the video signal and an analog voltage having 4096 gray-scales.

The output buffer 46 is a delay circuit for delaying a pixel signal by a predetermined delay time. Specifically, predetermined parameters with which the delay time is set are input from the control unit 100 to the output buffer 46. The output buffer 46 outputs a pixel signal to the switch 47 with a delay of the predetermined delay time, based on the input parameters and the clock signal.

The switch 47 is a switch circuit which selects and outputs either one of a pre-charge voltage and a pixel signal. For example, if the switch 47 selects the pre-charge voltage, the pre-charge voltage is applied to the D signal line, and charges which are stored on the D signal line are forced to be charged and discharged.

While there are 720 output channels OUT1 to OUT720 corresponding to one source driver circuit 40 in the example illustrated in FIG. 6, the present disclosure is not limited thereto.

### 7. Parameters for Delay Setting

In the following, the parameters with which the delay times are set are described. As the parameters with which the delay times are set, a direction parameter, a first delay time parameter, and a second delay time parameter are input to the output buffer 46.

The direction parameter defines a direction in which the delay operation starts. For example, the direction parameter is a 1-bit value. When the direction parameter is “0,” the delay operation starts from OUT1. When the direction parameter is “1,” the delay operation starts from OUT720.

The first delay time parameter defines a leading delay time for the delay operation. For example, the first delay time parameter is configured of 9-bit data. The first delay time parameter corresponds to the parameter with which the first delay time illustrated in FIG. 5B is set. In other words, the first delay time parameter is a parameter with which the delay time for each row of the pixels 10 is set, specifically, a delay time for each gate driver circuit 30. Stated differently, using the first delay time parameter, the delay time for each horizontal scanning period is set.

The second delay time parameter defines a delay time from the leading part of the delay operation. For example, the second delay time parameter is configured of 32-bit data. The second delay time parameter corresponds to the parameter with which the second delay time illustrated in FIG. 5B is set. In other words, the second delay time parameter is a parameter with which the delay time for columns of the pixels 10 is set, specifically, a delay time for each column-group of the pixels 10.

In the following, as specific example, the operations of the SD1 and SD16 that are most adjacent to the gate driver circuits 30 in FIG. 1 are described.

For the SD1, the direction parameter is set to “0”. For the SD16, the direction parameter is set to “1”. This starts the delay operation for the SD1 from the pixel 10 in the column most adjacent to the left side of the display area 21 in FIG. 1, and starts the delay operation for the SD16 from the pixel 10 in the column most adjacent to the right side of the display area 21.

Further, in order to be in phase with the scan signal from the IC1, the first delay time parameters for the SD1 and the SD16 are set to the delay amount T1 (a time corresponding to the resistance R1). Moreover, the second delay time parameters for the SD1 and the SD16 are set to delay amounts for each column-group (a time corresponding to a resistance value of a signal line between adjacent column-groups) is set. For example, a delay amount of the clock signal and a delay amount of the scan signal can previously be measured or calculated and the respective parameters can be set with the measured or calculated delay amounts.

This causes the SD1 to output pixel signals to the pixels 10 starting from the pixel 10 in the column most adjacent to the left side of the display area 21, with a delay of the delay amount T1 plus a predetermined delay time for each column-group. This causes the SD16 to output pixel signals to the pixels 10 starting from the pixel 10 in the column most adjacent to the right side of the display area 21, with a delay time of the delay amount T1 plus a predetermined delay time for each column-group. In this manner, the delay times that form the inverse chevrons as illustrated in FIGS. 5A and 5B can be set.

### 8. Summary

As described above, the image display device 1 according to the present embodiment includes: the display panel substrate 20 which includes the pixels 10 disposed in rows and columns; the control unit 100 which outputs the clock signal; the gate driver circuits 30 each of which outputs the control signal to pixels 10 row-by-row among the pixels 10 included in the display panel substrate 20, in synchronization with the clock signal; the lines 80 disposed on the display panel substrate 20 and supply the gate driver circuits 30 with the clock signal by cascading the control unit 100 and the gate driver circuits 30; and the one or more source driver circuits 40 each of which outputs pixel signals to pixels 10, among the pixels 10 included in the display panel substrate 20, with a delay of a first delay time which is different for each of the gate driver circuits 30.

This allows the source driver circuit 40 to output the pixel signal with a delay of a delay time different for each gate driver circuit 30, thereby driving the pixel 10 in a manner that the delay of the clock signal due to the line 80 is absorbed. In other words, this brings the control signal output from the gate driver circuit 30 and the pixel signal output from the source driver circuit 40 in phase, thereby reducing degradation of the display quality.

Moreover, in the present embodiment, the image display device 1 further includes the first COF substrates 50 connected to the display panel substrate 20, wherein one of the gate driver circuits 30 is mounted on each of the first COF substrates 50.

With this, the gate driver circuits 30 are mounted on the first COF substrates 50. Thus, the image display device 1 having narrowed frames is achieved, for example, by disposing the first COF substrates 50 on the rear side of the display panel substrate 20.

Moreover, the present embodiment, the first delay time depends on resistance of at least one line 80 among the lines 80, the at least one line 80 cascading the control unit 100 down to a gate driver circuit 30 corresponding to the first delay time among the gate driver circuits 30.

This allows a delay time to be appropriately set for each gate driver circuit 30, thereby improving the display quality.

Moreover, the present embodiment, the first delay time is longer for a gate driver circuit 30 located farther downstream of the gate driver circuits 30 cascaded.

This allows a delay time to be appropriately set for each gate driver circuit 30, thereby improving the display quality.

Moreover, the present embodiment, the one or more source driver circuits 40 each output the pixel signals to column-groups, each consisting of one or more of the columns of the pixels 10 included in the display panel substrate 20, with a delay of a total delay time which is a sum of the first delay time and a second delay time different for each of the column-groups.

This allows the pixel 10 to be driven in a manner that the delay of the control signal output from the gate driver circuit 30 is absorbed. This allows the delay time to be set according to the position of the pixel in the display area 21, thereby allowing the control signal output from the gate driver circuit 30 and the pixel signal output from the source driver circuit 40 to be brought in phase more appropriately. Accordingly, improved display quality is achieved.

Moreover, the present embodiment, the second delay time is longer for a column-group that is located farther away from the gate driver circuits 30, among the column-groups.

This allows the delay time to be appropriately set for each column-group of the pixels 10, thereby improving the display quality.

Moreover, a display control method according to the present embodiment is for controlling the image display device 1, the image display device 1 including: the display panel substrate 20 which includes the pixels 10 disposed in rows and columns; the control unit 100; the gate driver circuits 30; the one or more source driver circuits 40; and lines 80 disposed on the display panel substrate 20 and cascading the control unit 101) and the gate driver circuits 30, the display control method including: outputting, by the control unit 100, a clock signal; outputting, by each of the gate driver circuits 30, a control signal to pixels 10 row-by-row among the pixels 10 included in the display panel substrate 20, in synchronization with the clock signal supplied via the lines 80; and outputting, by each of the one or more source driver circuits 40, pixel signals to the pixels 10, among the pixels 10 included in the display panel substrate 20, with a delay of a delay time different for each of the gate driver circuits 30.

This allows the source driver circuit 40 to output the pixel signal with the delay of the delay time different for each gate driver circuit 30, thereby allowing the pixel 10 to be driven in the manner that the delay of the clock signal due to the line 80 is absorbed. In other words, this allows the control signal output from the gate driver circuit 30 and the pixel signal output from the source driver circuit 40 to be brought in phase, thereby reducing degradation of the display quality.

General and specific aspects of the present disclosure may be implemented by a system, apparatus, integrated circuit, computer program, or computer-readable recording medium such as a CD-ROM. The general and specific aspects of the present disclosure may also be implemented by any combination of systems, apparatuses, integrated circuits, computer programs, or computer-readable recording media.

### Other Embodiment

As set forth above, the embodiment has been described as an example of the technology as disclosed in the present application. However, the technology in the present disclosure is not limited thereto and applicable to various embodiments to which various modifications, permutations, additions, and omissions have been made.

Thus, in the following, other embodiments are illustrated.

For example, as illustrated in FIG. 1, the gate driver circuits 30 are disposed on the left and right sides of the display area 21 and the source driver circuits 40 are disposed on the top and bottom sides of the display area 21 in the above embodiment. However, the present disclosure is not limited thereto. At least either the gate driver circuits 30 or the source driver circuits 40 may be disposed on one side of the display area 21 only.

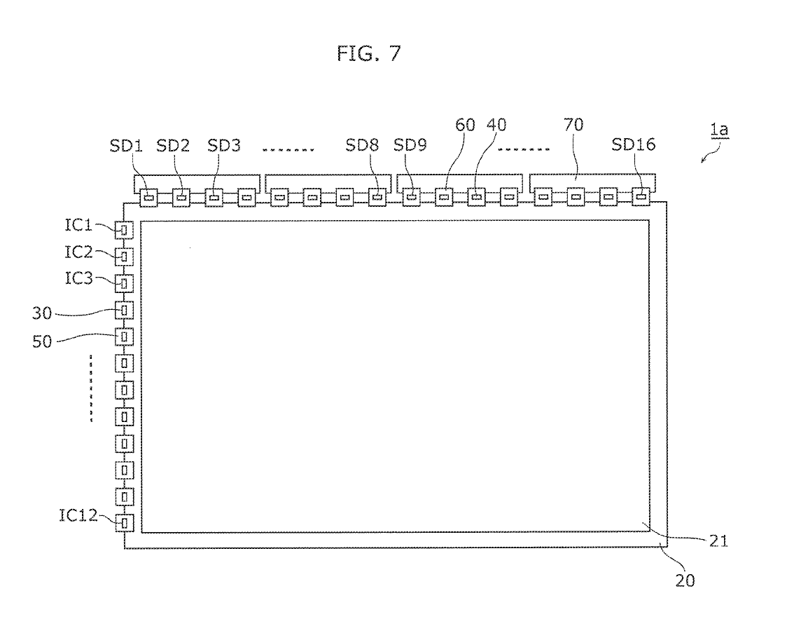

FIG. 7 is a schematic view of an image display device 1a according to a variation of the embodiment. As illustrated in FIG. 7, the image display device is may include the gate driver circuits 30 and the first COF substrates 50 only on the left side of the display area 21, and the source driver circuits 40 and the second COF substrates 60 only on the top side of the display area 21.

In this case, the control signal output from the gate driver circuit 30 is carried to the display area 21 from the left side to the right side. Thus, a delay of the control signal due to lines increases toward the right side of the display area 21.

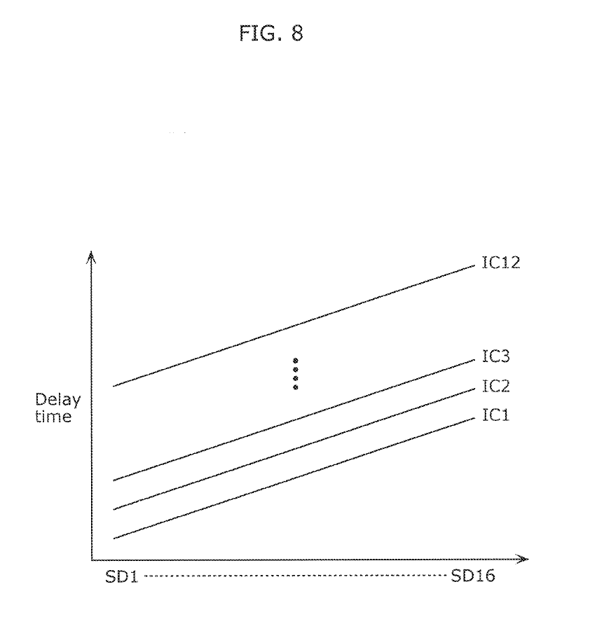

Accordingly, delay amounts set for the source driver circuits 40 are increasing as depicted by the graph illustrated in FIG. 8. FIG. 8 is a diagram illustrating delay times corresponding to source driver circuits 40 and the gate driver circuits 30 according to the variation of the above embodiment.

While the above embodiment has been described with reference to the gate driver circuits 30 mounted on the first COF substrates 50, the present disclosure is not limited thereto. For example, the gate driver circuits 30 may be mounted on the display panel substrate 20.

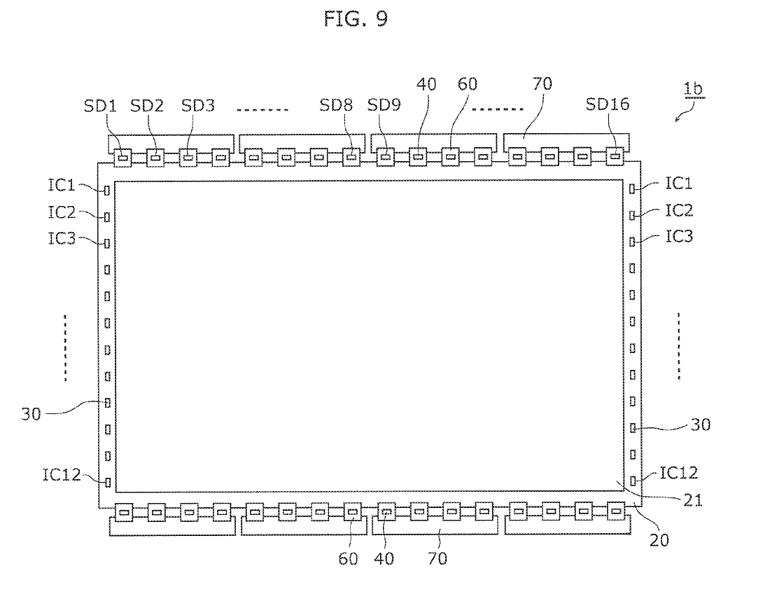

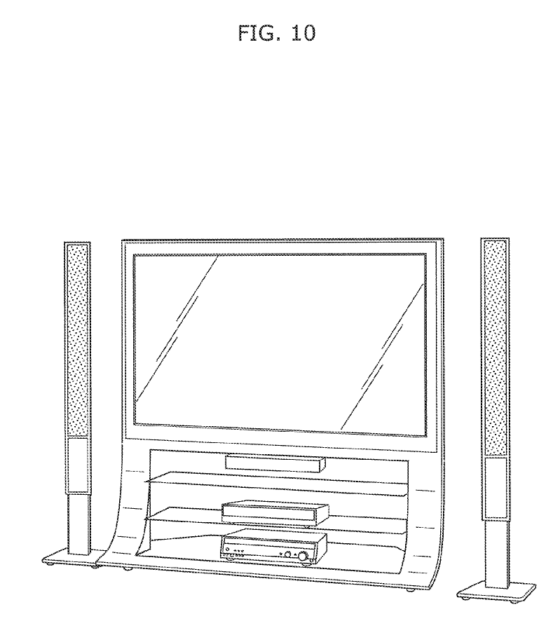

FIG. 9 is a schematic view of an image display device 1b according to another variation of the embodiment. As illustrated in FIG. 9, the gate driver circuits 30 are mounted around the periphery of the display area 21 of the display panel substrate 20. In other words, the image display device 1b is what is known as a COG (Chip On Glass) image display device.

Moreover, while the above embodiment has been described with reference to the plural number of source driver circuits 40 and the plural number of second COF substrates 60, the present disclosure is not limited thereto. The image display devices 1, 1a, and 1b according to the above embodiment and the variations thereof may include one source driver circuit 40 and one second COF substrate 60.

Moreover, the gate driver circuit 30 may be one-chip driver integrated circuits, or may include two or more chips of driver circuits. Stated differently, a plurality of driver integrated circuits may be mounted on one first COF substrate 50.

Moreover, while in the above embodiment, the circuit configuration of the pixels included in the image display device according to the present disclosure has been described with reference to FIG. 2, the circuit configuration of the pixels 10 is not limited thereto. For example, while the configuration is illustrated in FIG. 2 in which the enable switch 13, the drive transistor 12, and the light-emitting element 11 are disposed in the listed order between the anode supply line (VTFT) and the cathode supply line (VEL) in the light-emitting element 11, these elements may be disposed in a different order.

Moreover, while the above embodiment has been described assuming that the switches and the drive transistor 12 included in the pixel 10 are TFTs each including a gate electrode, a source electrode, and a drain electrode, these transistors may be bipolar transistors each including a base, collector, and emitter.

Moreover, the control unit 100 included in the image display device according to the embodiment described above is typically implemented in an LSI (Large Scale Integration) which is an integrated circuit. It should be noted that part of the control unit 100 included in the image display device may be integrated on the display panel substrate 20. Alternatively, the control unit 100 may be implemented in a dedicated circuit or a general-purpose processor. Alternatively, a field programmable gate array (FPGA) that is programmable after manufacturing the LSI or a reconfigurable processor that allows re-configuration of the connection and configuration of the LSI can be used.

Moreover, some of the functionalities of the gate drive unit, the data drive unit, and the control unit included in the organic electroluminescent display device according to the above embodiment may be implemented by a processor such as a central processing unit (CPU) executing programs.

The display device described above can be used as a flat-panel display device as illustrated in FIG. 10, for example. The display device described above is also applicable to any electronic devices, such as a television set, a personal computer, mobile phone, etc., which includes a display device.

It should be noted that the image display device described above is not limited to an organic EL display device, and may be, for example, a flat panel display device, such as a liquid-crystal display device and a plasma display panel (PDP) display device.

As such, the embodiment and variation thereof have been described as an example of the technology according to the present disclosure. For that purpose, the accompanying drawings and detailed description have been provided.

Thus, the components set forth in the accompanying drawings and detailed description include not only those essential to solve the problems but also ones unnecessary to solve the problems, for illustrating the above technology. Hence, the unnecessary components should not be acknowledged essential due to the mere fact that they are depicted in the accompanying drawings or set forth in the detailed description.

The above embodiments are for illustrating the technology of the present disclosure, and thus various modifications, permutations, additions, and omissions are possible in the scope of the appended claims and the equivalents thereof.

### INDUSTRIAL APPLICABILITY

The image display device and the display control method according to the present disclosure is applicable to various display devices such as a display of a television set, information appliance, etc., for example.

### REFERENCE SIGNS LIST

1, 1a, 1b image display device

10 pixel

11 light-emitting element

12 drive transistor

13 enable switch

14 scan switch

15 capacitor

16 REF switch

17 INT switch

20 display panel substrate

21 display area

30 gate driver circuit

40 source driver circuit

41 data reception and decoding unit

42 shift register

43 latch circuit

44 digital-to-analog converter

45 gamma setting circuit

46 output buffer

47 switch

50 first COF substrate

51 metal line

60 second COF substrate

70 PCB

80 line

90 film substrate

100 control unit

1. An image display device comprising:
a display panel substrate which includes pixels disposed in rows and columns;
a control unit configured to output a clock signal;
gate driver circuits each of which outputs a control signal to pixels row-by-row among the pixels included in the display panel substrate, in synchronization with the clock signal;
lines disposed on the display panel substrate and supply the gate driver circuits with the clock signal by cascading the control unit and the gate driver circuits; and
one or more source driver circuits each of which outputs pixel signals to pixels, among the pixels included in the display panel substrate, with a delay of a first delay time which is different for each of the gate driver circuits.

2. The image display device according to claim 1, further comprising
film substrates connected to the display panel substrate, wherein
one of the gate driver circuits is mounted on each of the film substrates.

3. The image display device according to claim 1, wherein
the first delay time depends on resistance of at least one line among the lines, the at least one line cascading the control unit down to a gate driver circuit corresponding to the first delay time among the gate driver circuits.

4. The image display device according to claim 1, wherein
the first delay time is longer for a gate driver circuit located farther downstream of the gate driver circuits cascaded.

5. The image display device according to claim 1, wherein
the one or more source driver circuits each output the pixel signals to column-groups, each consisting of one or more of the columns of the pixels included in the display panel substrate, with a delay of a total delay time which is a sum of the first delay time and a second delay time different for each of the column-groups.

6. The image display device according to claim 5, wherein
the second delay time is longer for a column-group that is located farther away from the gate driver circuits, among the column-groups.

7. A display control method for controlling an image display device, the image display device including:
a display panel substrate which includes pixels disposed in rows and columns;
a control unit;
gate driver circuits;
one or more source driver circuits; and
lines disposed on the display panel substrate and cascading the control unit and the gate driver circuits, the display control method comprising:
outputting, by the control unit, a clock signal;
outputting, by each of the gate driver circuits, a control signal to pixels row-by-row among the pixels included in the display panel substrate, in synchronization with the clock signal supplied via the lines; and
outputting, by each of the one or more source driver circuits, pixel signals to pixels, among the pixels included in the display panel substrate, with a delay of a delay time different for each of the gate driver circuits.
